(19) United States
(12) Patent Application Publication
(10) Pub. No.: US 2009/0138311 A1
(43) Pub. Date: May 28, 2009

(54) SYSTEM AND METHOD FOR COMPUTER AIDED WORK ORDER SCHEDULING

(76) Inventors: Michael Anthony Iacovone, Clermont, FL (US); Adhir Chobe, Port Orange, FL (US); Taras Zherukha, Port Orange, FL (US)

Correspondence Address: Masco Corporation, 21001 Van Born Road, Taylor, MI, 48480, US

(21) Appl. No.: 11/946,157

(22) Filed: Nov. 28, 2007

(51) Int. Cl. G06Q 10/00

(52) U.S. Cl. 705/8

(57) ABSTRACT

Disclosed is a method for scheduling work orders where a user receives a request to schedule a work order, and then a labor amount value is assigned to the work order request. The work order is assigned a labor amount requirement, and the labor amount requirement is compared to a labor amount capacity for the requested days. Additionally the scheduler attempts to verify any essential information. Finally the work order is assigned an actionable for dispatch status.

### BACKGROUND OF THE INVENTION

The present application relates to a computerized system for scheduling work orders where multiple work orders should be scheduled for a range of days.

Scheduling a work order for a service based company involves several aspects. The scheduler must ensure that the date desired is available, and he must ensure that the appropriate equipment and manpower is available. The scheduler must also check to make sure that the work order request has itself been validated and any payment that is required up front has been paid. Once these steps, and any other steps necessary for a particular business, have been accomplished the scheduler may schedule the work order request. The number of steps and the differences between them can often result in time backups and other problems when a manual scheduling system is used.

Typically when a work order is desired to be scheduled for a specific day a scheduler will book equipment and resources to that work order for the desired range of days months in advance. This locks a crew and set of resources into that work order for that specific range of days from the time it is scheduled until completion of the work order. When one crew becomes behind on their work orders, or is unable to work on a specific day, their work orders can get backed up. This can lead to several work orders being delayed beyond their scheduled date, and could potentially require a complete rescheduling of the work orders for a given time period.

It is an industry standard to assign an estimated labor dollar capacity to work crews and resources, and to assign a labor dollar requirement value to work orders, to aid in the scheduling process. Labor dollar capacity is a unit that describes how much labor a given crew can perform on a given day. The labor dollar capacity of a work crew can be determined any number of ways, one example of which is by determining the number of hours a crew can work and the estimated productivity of each member of that crew. Labor dollar requirements of a work order are a similar unit to labor dollar capacity. A labor dollar requirement value is used to describe the estimated value of labor required for completion of a given work order.

Currently work order schedulers use an estimated labor dollar capacity and requirement to determine if a given work crew is capable of performing a certain job by comparing the available labor dollar capacity to the labor dollar requirement of a work order. Then, if the work crew's labor dollar capacity is not exceeded the work crew is assigned that particular work order. When performing the scheduling process manually, use of a labor dollar capacity and a labor dollar requirement is difficult and time consuming due to the many comparisons and calculations that must occur.

### SUMMARY OF THE INVENTION

The applicant has devised a system and method for scheduling work orders. When a work order request is first received a requested range of days is associated with it and indicates when the customer would like the work done. After being received, the request is assigned a labor dollar value. Then that value is checked against the available labor dollar capacity of the requested range of days. Additionally, a user uses a computer to attempt to capture, validate, and save any essential information about the work order. After completion of the previous steps the work order is assigned an available for dispatch status.

These and other features of the present invention can be best understood from the following specification and drawings, the following of which is a brief description.

### BRIEF DESCRIPTION OF THE DRAWINGS

FIG. 1 is a flowchart illustrating an embodiment of a method for scheduling work orders.

FIG. 2 is a flowchart illustrating a second embodiment of a method for scheduling work orders.

FIG. 3 is a sample view of a graphical user interface pursuant to an embodiment a method for scheduling work orders.

FIG. 4 is a sample view of a graphical user interface pursuant to an embodiment a method for scheduling work orders.

FIG. 5 is a sample view of a graphical user interface pursuant to an embodiment a method for scheduling work orders.

FIG. 6 is a block diagram of a system used to implement an embodiment of a method for scheduling work orders.

### DETAILED DESCRIPTION OF AN EMBODIMENT

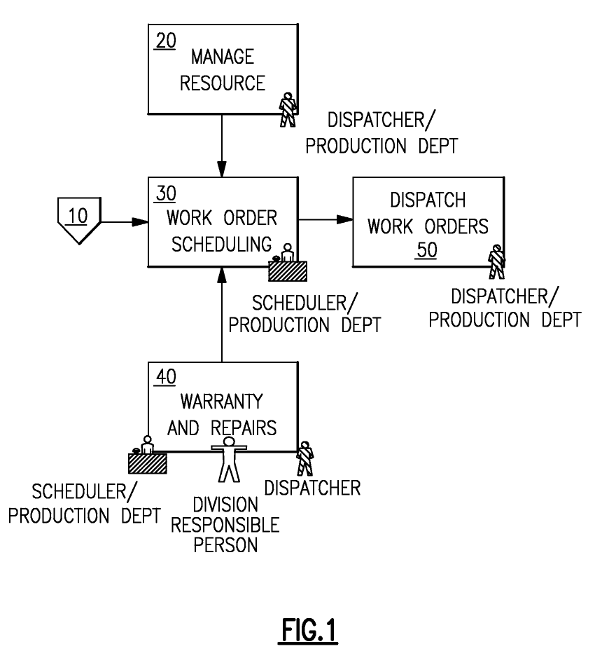

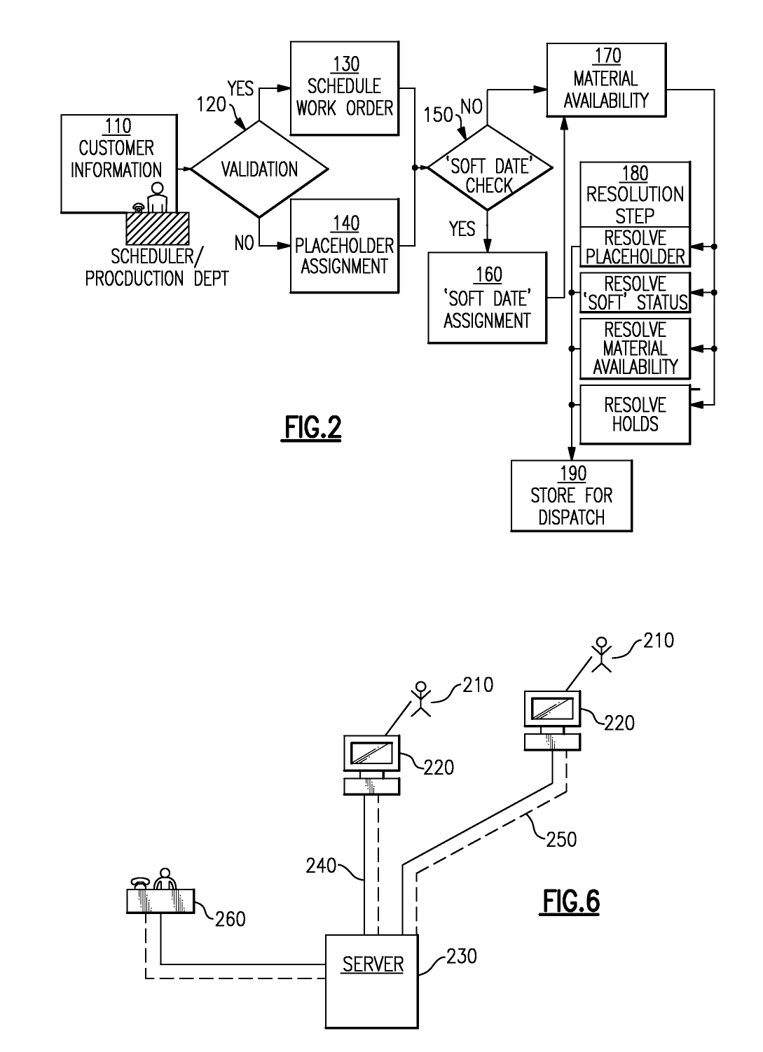

In order to start a computer aided scheduling process, such as the ones illustrated in FIGS. 1 and 2, a user 210, see FIG. 6[[ ]], (typically a salesperson, or employee) will log into a computer system and initiate a scheduling program. The software may have an option of varying levels of access. If such an option is implemented, the software checks the login information (such as user name and password) against a list of authorized users. If the login information is valid, then the user 210 will be granted an amount of access to the software corresponding to their access level. In this way a user 210 such as a customer or salesperson may be granted access to the system in “Read Only” capacity, thereby allowing them to track the status of a particular work order, while not allowing them to perform transactions. When an authorized user 210 logs in to the software, read-write access is granted and the user 210 may perform the computer aided scheduling method. Additionally, it is anticipated that the functionality of allowing a user to sort work orders, and to perform work order searches could be added to the scheduler program to allow for greater functionality and ease of use in both checking on a specific work order, and performing the below described scheduling method.

FIG. 1 illustrates one embodiment of the disclosed method, starting with a work order request being submitted in the work order request submission step 10 and ending with the work order request being confirmed and dispatched to a work order dispatch program in the work order dispatch step 50. After the work order request is submitted in the work order request submission step 10, along with a requested date for the work order to be scheduled for, the work order request is sent to the work order scheduling step 30.

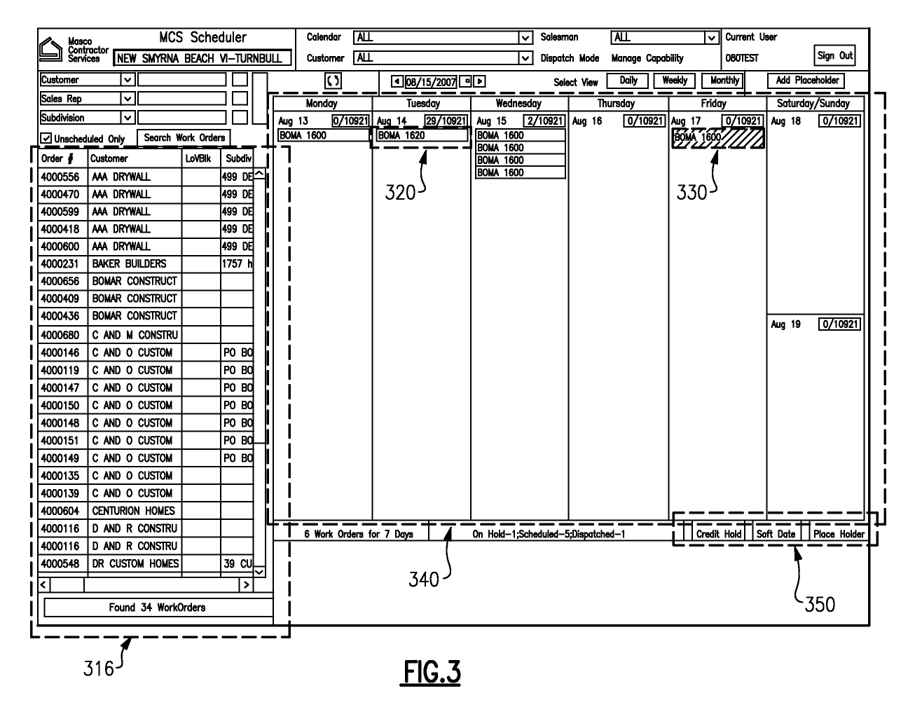

Initially a user 210 assigns a labor dollar requirement to the work order request based on the number of trade or product specific resources required and the average daily productivity of any required employees or based on any other desired criteria. Alternately the labor dollar requirement could be assigned by the software. Then the software receives information from both the manage capacity step 20, and the warranty and repairs step 40. Once the software has all the information needed, the user 210 may operate the scheduling program using the user interface shown in FIG. 3. In the user interface, the user 210 clicks on a work order from the search results area and drags it to the requested start date. When the user 210 attempts to drop the work order request on a given day or range of days, the software checks to see if the available labor dollar capacity is exceeded by the labor dollar requirement of the work order request. If the capacity is exceeded, the software allows the work order to be scheduled, and then provides a visual cue that the labor dollar capacity of the day or range of days has been exceeded. Once the work order has been scheduled in the work order scheduling step 30 it is sent to the dispatch work orders step 50 where it is stored for use with a dispatch program 190.

FIG. 2 illustrates a more detailed flow of the scheduling process for some embodiments. Initially a user 210 receives information from the customer and enters it into the system in the customer information step 110. If a work order is already in the system for the job the software moves on to the validation step 120. If no work order is in the system the user 210 enters the customer information and an initial placeholder is created. After all the customer information is entered the software, allows the user to examine the information in the validation step 120 to determine if the work order request should be validated. Checks contained at this stage could include, but are not limited to, checking the credit history to ensure that all prior bills are paid, checking to see if the customer has a user account with the company, or checking to see if any other holds have been placed on the customer's account. Certain holds could result in the software giving a visual cue at this stage to inform the user. By way of example, the software could display any work order with a credit hold highlighted in red. If the work order request fails validation then the next step is in the place holder assignment step 140 where a place holder is scheduled. The place holder reserves capacity for a date for the customer, should the work order become validated at a later time. If the work order request is validated in the validation step 120 the software sends the information to the schedule work order step 130 where it schedules the work order for the desired range of days. Additionally the schedule work order step 130 checks the labor dollar requirement of the work order against the labor dollar capacity for that range of days. If the labor dollar capacity is exceeded, then the work order is scheduled and a visual cue is displayed indicating that the labor dollar capacity has been exceeded.

Once the schedule work order step 130 and the placeholder assignment step 140 have determined the work order or placeholder status, the information is sent to the soft date check step 150 where the user 210, in collaboration with the customer, determines if a soft date should be used. A soft date is applied when a work order is scheduled to the calendar but requires a follow up action before dispatch. A follow up action usually comprises a phone call to the customer verifying that the job is ready or confirmed for dispatch, although the follow up action could be any number of other actions required to resolve any holds on the work order. In an alternative embodiment this determination is made by the user 210 and entered into the computer 220 in this step. If a soft date is required the soft date assignment step 160 assigns a soft date status to the work order. A work order with a soft date status can still proceed through the remainder of the software and the soft date status can be resolved during the resolution step 180. Additionally it is possible to implement a system where a work order with a soft date status has a visual cue associated with it. By way of example, this visual cue could include (but is not limited to) highlighting the work order in yellow.

After determining if a soft date status should be assigned, the work order is sent to the check material availability step 170 where the software determines if any required resources are available for the requested date. Additionally in the check material availability step 170 the software has the capability to allow a user 210 to reserve materials and resources for a given work order.

Once all determinations have been made in the previous steps 120, 130, 140, 150, 160, and 170 the work order is sent to the resolution step 180. In the resolution step 180 four functions are performed. First, the software prompts the user 210 to resolve any place holder status assigned to the work order. If a work order cannot be created and validated, the placeholder is not resolved and the work order cannot be actionable for dispatch. Second, resolution step 180 prompts the user 210 to resolve a soft date status assigned to the work order if one is present. Resolution of the soft date status involves performing any steps indicated by priorities which are attached to the work order, for example calling the customer to ensure that an inspection has been performed. Next, resolution step 180 again checks to make sure any materials necessary for completion of the job are available. If the necessary materials are not available or reserved then the work order cannot be actionable for dispatch. Next, the resolution step 180 prompts the user 210 to resolve any holds that are remaining on the work order. These remaining holds could be the result of a customer hold placed on the work order, a credit hold, or any number of other holds. Finally, after all four processes have been successfully resolved in the resolution step 180 the work order is sent to a dispatch program 190.

The embodiment described above does not assign a work crew or resources to a work order as a part of the scheduling process. If a work order does not have a crew and resources assigned to it when it reaches a dispatch process, a crew and resources will be assigned to it as a part of that process. It is additionally anticipated that some embodiments may include an “assign resources step” where crew and resources are assigned to the work order within the scheduling process.

FIGS. 3, 4, and 5 illustrate sample user interface screens that could be seen by a user 210 operating the scheduler program. In the screen shown in FIG. 3 the user will see a list 310 of work orders for scheduling on the left side of the screen. Immediately adjacent to this list 310 is a calendar view 340. Within the calendar view 340 are days representing each day of the week. The user may schedule work orders by dragging a work order from the list 310 onto one or more of the days contained in the calendar view 340. This process is illustrated at 320. Color coding may also be used in the scheduler program to indicate specific holds or other information affiliated with a work order. A sample work order with a credit hold 330 is shown in FIG. 3 to indicate how the color coding could work in some embodiments. The illustrated embodiment includes a color coding key 350 on the bottom of the user interface.

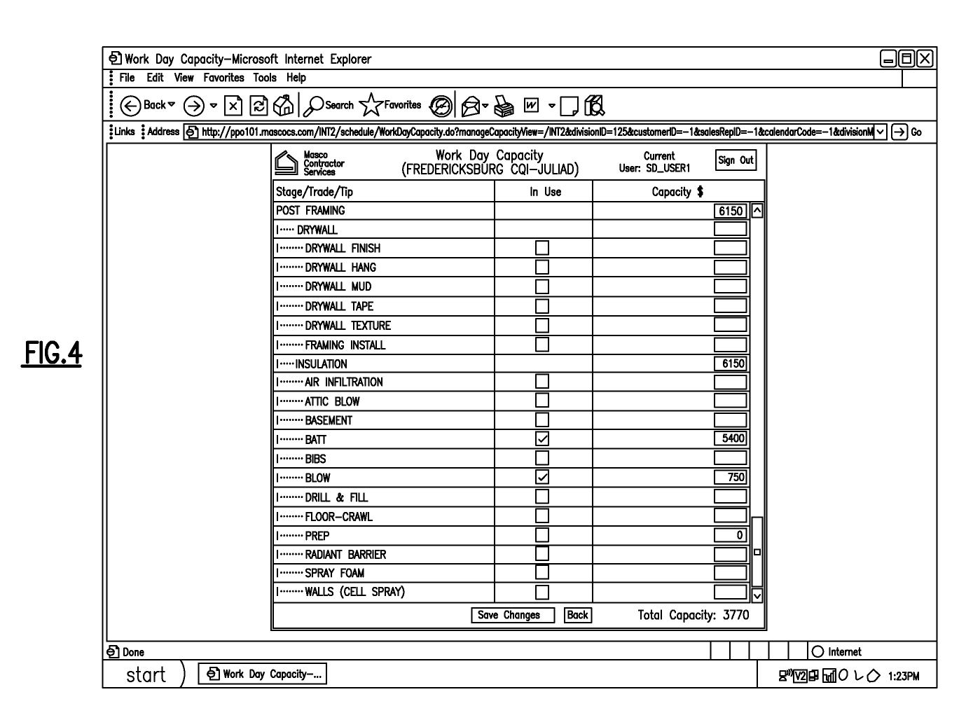

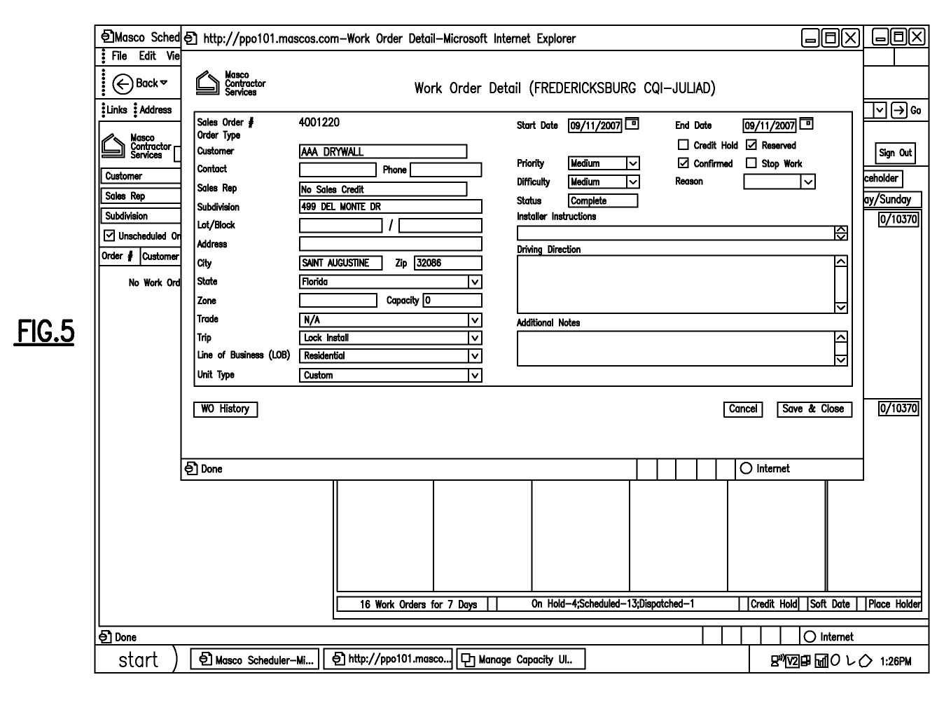

FIG. 4 shows a sample screen that the user 210 would see when selecting what trade/group a given work order should be scheduled in. FIG. 5 illustrates one example of a pop up window that could be used in the schedule work order step 130. The pop up window allows the user 210 to enter information about the customer and about the work order being scheduled.

After establishing the above described method it becomes necessary to develop a system for implementing it. FIG. 6 illustrates such a system. In this case the work order information is stored on one or more central computers (referred to as servers) 230. The actual processing of information and scheduling of the work order is performed on the servers 230, although it is anticipated that some or all of the information may be processed at the data entry computer 260 or the viewing computer 220. The user 210 accesses a user interface 390 which is available either over the internet 250 or over an internal network 240 and the data entry computer 260 may be connected physically to the servers 230 or through a modem or other network connection. This setup allows multiple different users 210 at varying locations (such as different store fronts) to input and schedule work orders for a single work crew, or for multiple varying work crews.

In one embodiment of the system a computer readable medium (such as a hard drive) is built into the server 230 and stores instructions for executing the above described method. Other embodiments could have the server 230 containing only the data associated with the work orders and the scheduling program operating on the remote computers 220, 260 via a computer readable medium located at each remote computer 220, 260.

The user interface 390 may be created using Java or any other suitable programming language. Additionally the user interface 390 could be accessible via a publicly accessible web page, by a protected web page, by a proprietary program, or by any other secure access method that is devised.

A worker of ordinary skill in this art would recognize that certain modifications to the previously disclosed embodiments would come within the scope of this invention. For that reason, the following claims should be studied to determine the true scope and content of this invention.

What is claimed is:

1. A method for scheduling a work order comprising:
1) receiving a request to schedule a work order for a range of at least one day;
2) assigning a labor amount requirement to said work order;
3) checking a requested range of at least one day for availability by at least comparing an available labor amount capacity of the requested range of at least one day against the labor amount requirement of the work order;
4) assigning an unscheduled work order to said range of at least one day by at least allowing a user to attempt to capture, validate, and save essential information during a work order scheduling process; and
5) assigning an actionable for dispatch status; and said work order is not assigned to a specific crew or resource during said method for scheduling a work order.

2. The method of claim 1, wherein step 4 includes:
validating a customer who submitted said request by at least checking said customer's credit; and
automatically creating a hold on said work order when there are unresolved credit issues.

3. The method of claim 1 wherein steps 1-5 additionally allow a user to place a manual stop on said work order.

4. The method of claim 3, further comprising the step of:
storing said work order for use with a dispatch module after it has been assigned an actionable for dispatch status.

5. The method of claim 1, further comprising the step of:
assigning a user accessing a work order scheduler an access level, where said access level determines a level of functionality available to said user.

6. The method of claim 1, further comprising the step of:
assigning priorities to said work order; and
said priorities remaining associated with said work order.

7. The method of claim 1, further comprising the step of:
creating a placeholder when essential information is not validated, thereby temporarily reserving the date when all other steps are met.

8. The method of claim 7, wherein step 5 does not occur when essential information is not validated.

9. The method of claim 1, further comprising the step of:
assigning a soft date status to said work order when an action should be performed by a user prior to step 5.

10. The method of claim 9, further comprising the step of:
allowing said user to remove a soft date status after said action has been performed.

11. A computer readable medium at least containing:
software that executes instructions enabling a user to schedule a work order;
said software comprising instructions for an interface capable of allowing a user to input information pertaining to a work order; and
said software performing at least the step of checking a requested range of at least one day for availability by at least comparing the requested range of at least one day's available labor amount capacity against a labor amount requirement of a work order request.

12. The system of claim 11 wherein said computer readable medium may be used in conjunction with:
at least one work order request entry unit;
at least one work order request database storage unit;
at least one work order scheduler unit capable of running said software;

13. The system of claim 12 wherein all of said at least one work order request entry unit, said at least one work order request database storage unit, and said at least one work order scheduler unit may be a single machine.

14. The computer readable medium of claim 11 wherein said software additionally contains instructions for displaying an interface capable of allowing a user to view all scheduled work orders.

15. The computer readable medium of claim 14 wherein said interface is capable of allowing a user to filter and view each of said work orders by at least one criteria.
